(19) United States
(12) Patent Application Publication
(10) Pub. No.: US 2022/0351151 A1
(43) Pub. Date: Nov. 3, 2022

(54) ELECTRONIC APPARATUS AND CONTROLLING METHOD THEREOF

(71) Applicant: SAMSUNG ELECTRONICS CO., LTD., Suwon-si, Gyeonggi-do (KR)

(72) Inventors: Hyungtak CHOI, Suwon-si, Gyeonggi-do (KR); Lohith RAVURU, Suwon-si, Gyeonggi-do (KR); Haehun YANG, Suwon-si, Gyeonggi-do (KR)

(21) Appl. No.: 17/428,211

(22) PCT Filed: Jul. 9, 2021
(86) PCT No.: PCT/KR2021/008778

§ 371 Date: Aug. 3, 2021

(30) Foreign Application Priority Data
Oct. 27, 2020 (KR) 10-2020-0140613

(51) Int. Cl. G06Q 10/10; G06F 40/284; G06V 30/18

(52) U.S. Cl. CPC G06Q 10/1095; G06F 40/284; G06V 30/18

(57) ABSTRACT

Disclosed is an electronic apparatus. The electronic apparatus includes: a display, a memory storing at least one instruction, and a processor connected to the memory and the display and configured to control the electronic apparatus, the processor, by executing the at least one instruction, is configured to: based on receiving a command for adding a schedule being input while an image is displayed on the display, obtain a plurality of texts by performing text recognition of the image, obtain main datetime information corresponding to each of a plurality of pieces of schedule information and sub-datetime information corresponding to the main datetime information by causing the plurality of obtained texts to be provided to a first neural network model, and update schedule information of a user based on the obtained datetime information, and the first neural network model is configured to be trained to output main datetime information and sub-datetime information corresponding to the main datetime information based on receiving a plurality of pieces of datetime information.

### TECHNICAL FIELD

The disclosure relates to an electronic apparatus which provides a schedule management function and a controlling method thereof.

### CROSS-REFERENCE TO RELATED APPLICATION(S)

This application claims benefit of priority to Korean Patent Application No. 10-2020-0140613, filed on Oct. 27, 2020, in the Korean Intellectual Property Office, the disclosure of which is incorporated by reference herein in its entirety.

### BACKGROUND ART

Recently, along with distribution of smartphones and development of technologies related to the smartphones, users normally manage a schedule using the smartphones. When adding a schedule by extracting a text from an image including information on a multiple schedule, there is a problem that an individual schedule is identified based on all datetime information included in the image.

In this case, the identified individual schedule is difficult for the user to recognize at a glance, and accordingly, there are demands for a method for providing clearly organized schedule information to a user by extracting a text from an image.

### DISCLOSURE

### Technical Problem

Embodiments of the disclosure provide an electronic apparatus which provides effectively arranged schedule information to a user and a controlling method thereof.

### Technical Solution

According to an example embodiment, an electronic apparatus is provided, the electronic apparatus including: a display, a memory storing at least one instruction, and a processor connected to the memory and the display and configured to control the electronic apparatus, wherein the processor, by executing the at least one instruction, is configured to: based on receiving a command for adding a schedule being input while an image is displayed on the display, obtain a plurality of texts by performing text recognition of the image, obtain main datetime information corresponding to each of a plurality of pieces of schedule information and sub-datetime information corresponding to the main datetime information by providing the plurality of obtained texts to a first neural network model, and update schedule information based on the obtained datetime information, wherein the first neural network model is configured to be trained to output main datetime information and sub-datetime information corresponding to the main datetime information based on receiving a plurality of pieces of datetime information.

According to an example embodiment, a method for controlling an electronic apparatus is provided, the method including: based on receiving a command for adding a schedule being input while an image is displayed on the display, obtaining a plurality of texts by performing text recognition of the image, obtaining main datetime information corresponding to each of a plurality of pieces of schedule information and sub-datetime information corresponding to the main datetime information by providing the plurality of obtained texts to a first neural network model, and updating schedule information based on the obtained datetime information, in which the first neural network model is trained to output main datetime information and sub-datetime information corresponding to the main datetime information by receiving a plurality of pieces of datetime information.

### Effect of Invention

According to various example embodiments of the disclosure, it is possible to enhance user's convenience when the user manages multiple schedules.

### DESCRIPTION OF DRAWINGS

The above and other aspects, features and advantages of certain embodiments of the present disclosure will be more apparent from the following detailed description, taken in conjunction with the accompanying drawings, in which:

FIG. 1 is a diagram illustrating an example method for adding a multiple schedule to a calendar;

FIG. 2 is a block diagram illustrating an example configuration of an electronic apparatus according to various embodiments;

FIG. 3A is a diagram illustrating an example multiple schedule extraction method according to various embodiments;

FIG. 3B is a diagram illustrating an example multiple schedule extraction method according to various embodiments;

FIG. 3C is a diagram illustrating an example multiple schedule extraction method according to various embodiments;

FIG. 3D is a diagram illustrating an example multiple schedule extraction method according to various embodiments;

FIG. 4 is a diagram illustrating an example of obtaining boundary information according to various embodiments;

FIG. 5A is a diagram illustrating an example first neural network model according to various embodiments;

FIG. 5B is a diagram illustrating an example first neural network model according to various embodiments;

FIG. 5C is a diagram illustrating an example first neural network model according to various embodiments;

FIG. 6 is a diagram illustrating an example second neural network model according to various embodiments;

FIG. 7 is a diagram illustrating an example method for adding a plurality of multiple schedules according to various embodiments;

FIG. 8A is a diagram illustrating various types of user commands according to various embodiments;

FIG. 8B is a diagram illustrating various types of user commands according to various embodiments;

FIG. 9 is a diagram illustrating an example method for removing the multiple schedule according to various embodiments;

FIG. 10 is a block diagram illustrating example configuration of the electronic apparatus according to various embodiments; and

FIG. 11 is a flowchart illustrating example method of controlling the electronic apparatus according to various embodiments.

### DETAILED DESCRIPTION OF EXEMPLARY EMBODIMENTS

Hereinafter, the disclosure will be described in greater detail with reference to the accompanying drawings.

The terms used in embodiments of the disclosure have been selected as widely used general terms as possible in consideration of functions in the disclosure, but these may vary in accordance with the intention of those skilled in the art, the precedent, the emergence of new technologies and the like. In addition, in a certain case, there may also be an arbitrarily selected term, in which case the meaning will be described in the description of the disclosure. Therefore, the terms used in the disclosure should be defined based on the meanings of the terms themselves and the contents throughout the disclosure, rather than the simple names of the terms.

In this disclosure, the terms such as “comprise”, “may comprise”, “consist of”, or “may consist of” are used herein to designate a presence of corresponding features (e.g., elements such as number, function, operation, or part), and not to preclude a presence of additional features.

It should be understood that the expression such as “at least one of A or/and B” expresses any one of “A”, “B”, or “at least one of A and B”.

The expressions “first,” “second” and the like used in the disclosure may denote various elements, regardless of order and/or importance, and may be used to distinguish one element from another, and does not limit the elements.

If it is described that a certain element (e.g., first element) is “operatively or communicatively coupled with/to” or is “connected to” another element (e.g., second element), it should be understood that the certain element may be connected to the other element directly or through still another element (e.g., third element).

Unless otherwise defined specifically, a singular expression may encompass a plural expression. It is to be understood that the terms such as “comprise” or “consist of” are used herein to designate a presence of characteristic, number, step, operation, element, part, or a combination thereof, and not to preclude a presence or a possibility of adding one or more of other characteristics, numbers, steps, operations, elements, parts or a combination thereof.

A term such as “module” or a “unit” in the disclosure may perform at least one function or operation, and may be implemented as hardware, software, or a combination of hardware and software. Further, except for when each of a plurality of “modules”, “units”, and the like needs to be realized in an individual hardware, the components may be integrated in at least one module and be implemented in at least one processor (not illustrated).

In this disclosure, a term “user” may refer to a person using an electronic apparatus or an apparatus using an electronic apparatus (e.g., an artificial intelligence electronic apparatus).

Hereinafter, various example embodiments of the disclosure will be described in greater detail with reference to the accompanying drawings.

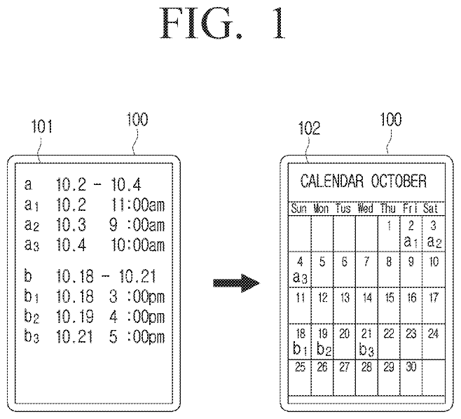

FIG. 1 is a diagram illustrating an example method for adding a multiple schedule to a calendar.

An electronic apparatus 100 may refer to an electronic apparatus that can be carried by a user. In FIG. 1, it is illustrated that the electronic apparatus 100 is implemented as a smartphone, but there is no limitation thereto, and the electronic apparatus 100 may be implemented as an electronic apparatus capable of performing a schedule management function, for example, and without limitation, various apparatuses such as a table PC, a mobile phone, a video phone, a laptop PC, a netbook computer, a workstation, a PDA, a portable multimedia player (PMP), an MP3 player, a camera, a virtual reality (VR) implementation device, a wearable device, or the like.

Through this disclosure, a “plan” and a “schedule” may be used interchangeably as terms having the same or similar meaning.

Referring to FIG. 1, information on a schedule a and a schedule b are mixed on a screen 101 including information on a plurality of multiple schedules. For example, the schedule a includes a1, a2, and a3 as sub-schedules and the schedule b includes b1, b2, and b3 as sub-schedules. The multiple schedule may refer to a schedule such as the schedule a and the schedule b each of which includes sub-schedules for the corresponding schedule.

In response to a user input for schedule management, the electronic apparatus 100 may add information on the plurality of multiple schedules on a calendar application and provide a UI corresponding to the added information to the user. The screen 101 including the information on the plurality of multiple schedules may be configured with a text or image file, and when the screen 101 is configured with the image file, the electronic apparatus 100 may extract a text from the image file using a text recognition method such as OCR.

An electronic apparatus of the related art recognizes all of the sub-schedules a1, a2, a3, b1, b2, and b3 of the multiple schedules as individual schedules based on the text information included in the screen 101 including the information on the plurality of multiple schedules, and accordingly, all of the identified individual schedules were displayed on a UI 102 of the calendar application.

On the UI 102 of the calendar application illustrated in FIG. 1, all of the sub-schedules of the schedule a and the schedule b are arranged on different dates. If the sub-schedules of each schedule are on the same date, the user receives a UI in which the information on the sub-schedules of the schedule a and the schedule b are mixed, and accordingly, the user may not grasp the information on the schedules at a glance.

In the disclosure, in order to address the above-mentioned problems, an electronic apparatus which provides a UI in which schedules are clearly divided so that a user does not confuse a plurality of sub-schedules of each schedule, and a controlling method thereof will be described.

Hereinafter, various example embodiments capable of providing effectively arranged schedule information to the user will be described in greater detail.

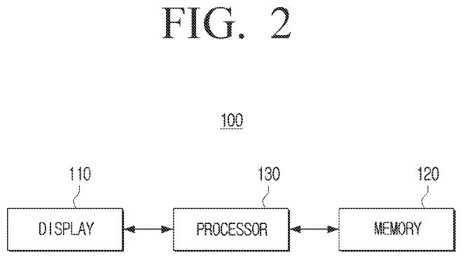

FIG. 2 is a block diagram illustrating an example configuration of an electronic apparatus according to various embodiments.

Referring to FIG. 2, the electronic apparatus 100 according to an embodiment of the disclosure may include a display 110, a memory 120, and a processor (e.g., including processing circuitry) 130.

The display 110 may be implemented as various types of display such as, for example, and without limitation, a liquid crystal display (LCD), an organic light emitting diodes (OLED) display, a quantum dot light-emitting diodes (QLED) display, a plasma display panel (PDP), and the like. The display 110 may also include a driving circuit or a backlight unit which may be implemented in a form of a TFT, a low temperature poly silicon (LTPS) TFT, or an organic TFT (OTFT). The display 110 may be implemented as a touch screen combined with a touch sensor, a flexible display, a 3D display, and the like.

The memory 120 may store data necessary for various embodiments of the disclosure. The memory 120 may be implemented in a form of a memory embedded in the electronic apparatus 100 or implemented in a form of a memory detachable from the electronic apparatus 100 according to data storage purpose. For example, data for operating the electronic apparatus 100 may be stored in a memory embedded in the electronic apparatus 100, and data for an extended function of the electronic apparatus 100 may be stored in a memory detachable from the electronic apparatus 100. The memory embedded in the electronic apparatus 100 may be implemented as at least one of, for example, and without limitation, a volatile memory (e.g., a dynamic RAM (DRAM), a static RAM (SRAM), a synchronous dynamic RAM (SDRAM), or the like), a non-volatile memory (e.g., one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive or a solid state drive (SSD), and the like. In addition, the memory detachable from the electronic apparatus 100 may be implemented as a memory card (e.g., a compact flash (CF), secure digital (SD), a micro secure digital (Micro-SD), a mini secure digital (Mini-SD), extreme digital (xD), a multi-media card (MMC), or the like), an external memory connectable to a USB port (e.g., a USB memory), and the like.

The memory 120 according to an embodiment of the disclosure may store at least one command and at least one neural network model. However, the neural network model may be stored in a separate server (not illustrated), rather than the electronic apparatus 100. In this case, the electronic apparatus 100 may include a communicator (not illustrate), and the processor 130 may control the communicator to transmit and receive data with the server storing the neural network model.

The processor 130 may include various processing circuitry and generally control the operations of the electronic apparatus 100. For example, the processor 130 may be connected to each element of the electronic apparatus 100 to generally control the operations of the electronic apparatus 100. For example, the processor 130 may be connected to the display 110 and the memory 120 to control the operations of the electronic apparatus 100.

According to an embodiment, the processor 130 may include various types of processing circuitry, including, for example, and without limitation, a digital signal (DSP), a microprocessor, a central processing unit (CPU), a micro controller unit (MCU), a micro processing unit (MPU), a neural network processing unit (NPU), a controller, an application processor (AP), a dedicated processor, and the like, but it is described as the processor 130 in this disclosure.

The processor 130 may be implemented as System on Chip (SoC) or large scale integration (LSI) or may be implemented in form of a field programmable gate array (FPGA). In addition, the processor 130 may include a volatile memory such as an SRAM.

The function related to the artificial intelligence according to the disclosure may include various processing circuitry and/or executable program elements and may, for example, be operated through the processor 130 and the memory 120. The processor 130 may be formed of one or a plurality of processors. The one or the plurality of processors may be a general-purpose processor such as a CPU, an AP, or a digital signal processor (DSP), a graphic dedicated processor such as a GPU or a vision processing unit (VPU), or an artificial intelligence dedicated processor such as a neural network processing unit (NPU), or the like. The one or the plurality of processors 130 may perform control to process the input data according to a predefined action rule stored in the memory 120 or an artificial intelligence model. In addition, if the one or the plurality of processors are artificial intelligence dedicated processors, the artificial intelligence dedicated processor may be designed to have a hardware structure specialized in processing of a specific neutral network model.

The predefined action rule or the neural network model may be formed through training. Being formed through training herein may, for example, refer to a predefined action rule or a neural network model set to perform a desired feature (or object) being formed by training a basic neural network model using a plurality of pieces of learning data by a learning algorithm. Such training may be performed in a device demonstrating artificial intelligence according to the disclosure or performed by a separate server and/or system. Examples of the learning algorithm include supervised learning, unsupervised learning, semi-supervised learning, or reinforcement learning, but is not limited to these examples.

The neural network model may include a plurality of neural network layers. The plurality of neural network layers have a plurality of weight values, respectively, and execute neural network processing through a processing result of a previous layer and processing between the plurality of weights. The plurality of weights of the plurality of neural network layers may be optimized by the training result of the neural network model. For example, the plurality of weights may be updated to reduce or minimize a loss value or a cost value obtained by the neural network model during the training process. The artificial neural network may include deep neural network (DNN), and, may include, for example, and without limitation, a convolutional neural network (CNN), deep neural network (DNN), recurrent neural network (RNN), restricted Boltzmann machine (RBM), deep belief network (DBN), bidirectional recurrent deep neural network (BRDNN), deep Q-network, or the like, but there is no limitation to these examples.

If a user command for adding a schedule is input while an image is displayed on the display 110 by executing at least one instruction stored in at least one memory 120, the processor 130 according to an embodiment may obtain a plurality of texts by performing text recognition of the image.

The user may obtain information related to the schedule through an image or text file on a web browser or an application. When obtaining the information related to the schedule through the text file, it is not necessary to perform the operation in which the processor 130 performs text recognition to obtain a plurality of texts from the image. However, the user normally uses the electronic apparatus 100 to obtain the information related to the schedule included in the screen on the web browser or the application, and accordingly, in this application, the operation of the processor 130 will be described by assuming that the user obtains the information related to the schedule through the image file.

The processor 130 according to an embodiment of the disclosure may use an optical character recognition (OCR) method when obtaining a text. The OCR method is a typical technology of extracting a text from an image.

The processor 130 may obtain main datetime information corresponding to each of a plurality of pieces of schedule information and sub-datetime information corresponding to the main datetime information by inputting the plurality of obtained texts to a first neural network model.

The processor 130 according to an embodiment of the disclosure may perform a function related to artificial intelligence using a neural network model. The neural network model herein may be a model subjected to machine learning based on a plurality of images. For example, and without limitation, the neural network model may include a model trained based on deep neural network (DNN) based on at least one of a plurality of sample images or learning images.

The deep neural network (DNN) may be a typical example of the artificial neural network model demonstrating cranial nerves. In this disclosure, the operations of the electronic apparatus 100 will be described assuming that the neural network model is the DNN. However, the DNN-based model is one of various embodiments and the neural network model disclosed in this application is not limited to the DNN-based model.

For example, the first neural network model according to an embodiment may include a model trained to perform natural language processing through machine learning, and the first neural network model according to an embodiment may be a model trained to output the main datetime information and the sub-datetime information corresponding to the main datetime information by receiving a plurality of pieces of datetime information.

The main datetime information according to an embodiment may refer to datetime information corresponding to a schedule including all of date and time corresponding to sub-schedules among information on multiple schedules. Referring to FIG. 1, datetime information corresponding to a including all of date and time of sub-schedules a1, a2, and a3 may include the main datetime information according to an embodiment. In this case, the main datetime information may be information corresponding to October 2, October 3, and October 4.

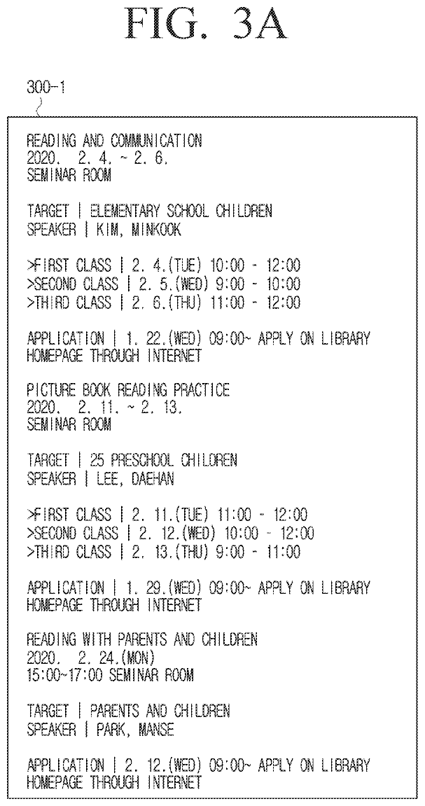

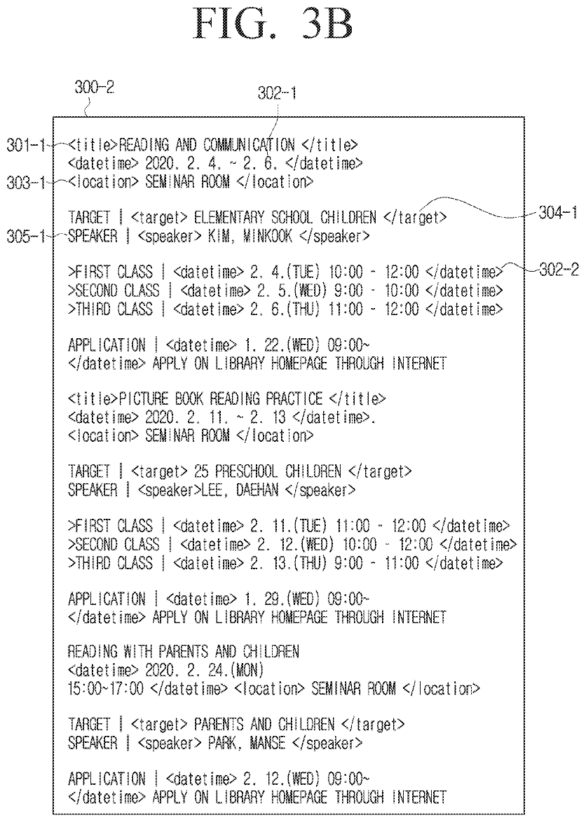

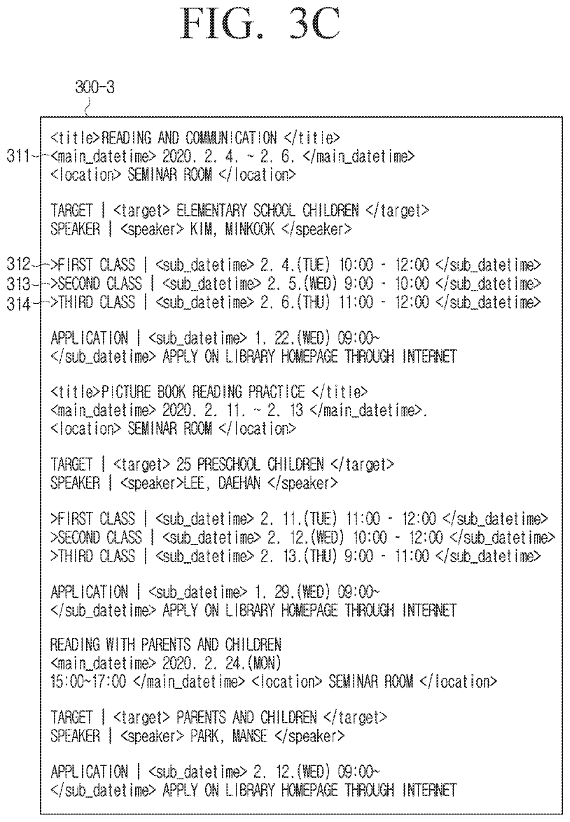

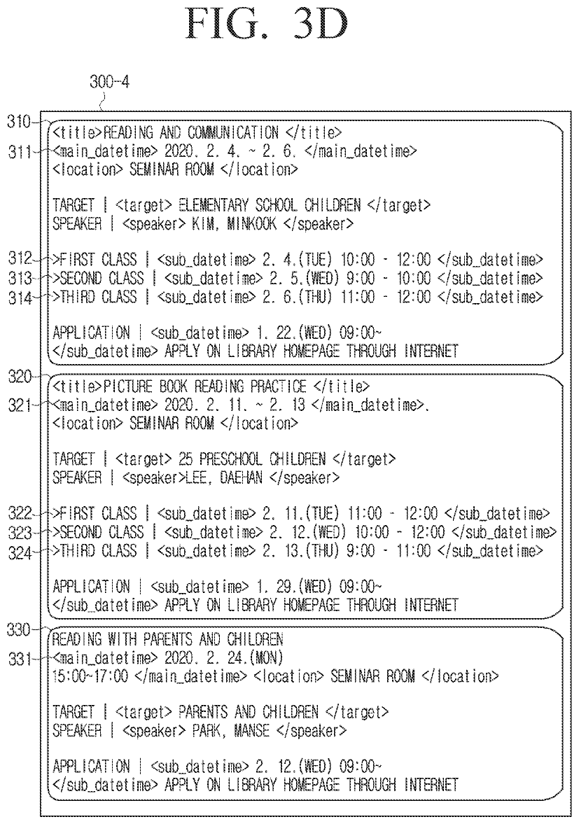

The sub-datetime information according to an embodiment may refer to datetime information corresponding to the sub-schedule among the information on the multiple schedules. Referring to FIG. 1, datetime information corresponding to date and time of sub-schedules a1, a3, and a3 corresponding to the schedule a may include the sub-datetime information. The processor 130 may update the schedule information of the user based on the obtained main datetime information and the sub-datetime information corresponding to the main datetime information. For example, the processor 130 may identify the main datetime information and the sub-datetime information corresponding to the main datetime information as one schedule package, and this will be described in greater detail below with reference to FIGS. 3A, 3B, 3C and 3D.

A plurality of pieces of datetime information input to the first neural network model to train the first neural network model may include first datetime information tagged as the main datetime information and second datetime information tagged as the sub-datetime information.

The first neural network model according to an embodiment may be trained to output text information corresponding to schedule boundary information by receiving a plurality of pieces of text information, and the processor 130 may obtain the schedule boundary information corresponding to each of the plurality of pieces of schedule information by inputting the plurality of obtained texts to the first neural network model.

The schedule boundary information herein may include information on a final text or a first text corresponding to each schedule, when the plurality of multiple schedules are sequentially arranged in the plurality of pieces of text information. The processor 130 according to an embodiment may update the user schedule information based on the obtained boundary information, the main datetime information corresponding to each of the plurality of pieces of schedule information, and the sub-datetime information corresponding to the main datetime information.

In addition, the processor 130 according to an embodiment may obtain the schedule boundary information corresponding to each of the plurality of pieces of schedule information by inputting (e.g., providing) the plurality of obtained texts to a second neural network model, and update the user schedule information based on the obtained schedule boundary information, the main datetime information corresponding to each of the plurality of pieces of schedule information, and the sub-datetime information corresponding to the main datetime information.

The second neural network model herein may include a model trained to output the text information corresponding to the schedule boundary information by receiving the plurality of pieces of text information. In this case, the electronic apparatus 100 may more accurately identify the boundary information for dividing the plurality of schedules, and accordingly, it is possible to provide more convenient service to the user who manages the plurality of schedules.

The processor 130 according to an embodiment may obtain schedule title information, location information, and datetime information corresponding to each of the plurality of pieces of schedule information by inputting the plurality of obtained texts to the first neural network model. The processor 130 may update the schedule information of the user based on the obtained schedule title information, location information, and datetime information.

In this case, the processor 130 may identify a schedule package including sub-schedules included in the plurality of multiple schedules based on the title information and the location information, not only the datetime information. For example, the processor 130 may identify that the sub-schedules progressing at the same location belongs to the same schedule package. In addition, the processor 130 may identify that the sub-schedules having the same keyword in the schedule title information corresponding to each sub-schedule belong to the same schedule package.

The first neural network model according to an embodiment of the disclosure may be a model trained to divide and output the schedule title information, the location information, and the datetime information by receiving the plurality of pieces of text information. The plurality of pieces of text information input to the first neural network model to train the first neural network model herein may include a first text tagged as the schedule title information, a second text tagged as the location information, and a third text tagged as the datetime information.

If the date and time of the plurality of pieces of main datetime information obtained from the first neural network model are overlapped, the processor 130 according to an embodiment of the disclosure may select one of the plurality of pieces of main datetime information. The processor 130 according to an embodiment may perform removal processing for the main datetime information not selected among the plurality of pieces of main datetime information. The processor 130 may update the user schedule information based on the selected main datetime information and sub-datetime information corresponding to the selected main datetime information.

The processor 130 according to an embodiment may control the display 110 to display a guide UI including the plurality of pieces of schedule information obtained from the first neural network model, and update the schedule information of the user based on the schedule information selected on the guide UI.

A user command for adding the schedule according to an embodiment of the disclosure may include at least one of a touch input for the image or a user voice command.

The processor 130 according to an embodiment may divide the plurality of texts in a predetermined unit in order to efficiently perform the natural language processing through the first neural network model. The predetermined unit according to an embodiment may be a unit such as one page, one paragraph, or one line. In addition, the processor 130 according to an embodiment may normalize the divided text, tokenize the normalized text and input the text to the first neural network model.

The normalizing may refer, for example, to an operation of converting differently expressed words among the words included in the text information into one word having the same meaning. For example, since Unite States (US) and United States of America (USA) are words having the same meaning, these words may be normalized to one word, US. The processor 130 may convert uppercase or lowercase during the normalizing process and remove unnecessary words.

The tokenizing may refer, for example, to an operation of dividing the text information input to the neural network model into a form (hereinafter, token) suitable for the natural language processing of the processor 130. The processor 130 according to an embodiment may set the token for dividing the text information as a “word”, The processor 130 according to another embodiment may set the token as a “sentence”.

FIGS. 3A, 3B, 3C and 3D are diagrams illustrating multiple example schedule extraction methods according to various embodiments.

FIG. 3A illustrates text information 300-1 obtained by the processor 130 by performing text recognition from an image including schedule information. The obtained text information 300-1 may include information on three multiple schedules with titles “reading and communication”, “picture book reading practice”, and “reading with parents and children”. Each of the schedules with the titles “reading and communication” and “picture book reading practice” among the multiple schedules include sub-schedules corresponding to three classes. The obtained text information 300-1 according to an embodiment may include various types of information such as title information, location information, datetime information, and speaker information.

FIG. 3B illustrates a state 300-2 in which the processor 130 according to an embodiment of the disclosure identifies various types of information from the obtained text information 300-1. The processor 130 according to an embodiment may identify title information 301-1, datetime information 302-1, 302-2, location information 303-1, target information 304-1, and speaker information 305-1 for the multiple schedule with the title “reading and communication” and include a tag corresponding to the information of each type in the text information.

FIG. 3C illustrates a state 300-3 in which the processor 130 according to an embodiment of the disclosure identifies various types of information from the obtained text information 300-1 and divides and identifies the main datetime information and the sub-datetime information corresponding to the main datetime information. For example, the processor 130 according to an embodiment may divide and identify main datetime information 311 and sub-datetime information 312, 313, and 314 corresponding to the main datetime information among the datetime information of the multiple schedule with the title “reading and communication”.

In addition, the processor 130 may include tags corresponding to the main datetime information 311 and the sub-datetime information 312, 313, and 314 corresponding to the main datetime information in the text information. The reason for that the processor 130 according to an embodiment performs identification by dividing the main datetime information 311 and the sub-datetime information 312, 313, and 314 is to divide the plurality of multiple schedules based on the main datetime information 311. This will be described in greater detail below with reference to FIG. 3D.

FIG. 3D illustrates a state 300-4 in which the processor 130 according to an embodiment of the disclosure performs identification by dividing the main datetime information and the sub-datetime information corresponding to the main datetime information, and then identifies each of the multiple schedules as one schedule package based on the main datetime information.

The processor 130 according to an embodiment may identify that the main datetime information 311 and the plurality of pieces of sub-datetime information 312, 313, and 314 corresponding to the main datetime information 311 corresponding to the multiple schedule with the title “reading and communication” are the datetime information included in one schedule package 310.

In the same or similar manner, the processor 130 according to an embodiment may identify that main datetime information 321 and a plurality of pieces of sub-datetime information 322, 323, and 324 corresponding to the main datetime information 321 corresponding to the multiple schedule with the title “picture book reading practice” may be identified as datetime information included in one schedule package 320. If a sub-schedule is not identified for the schedule with the title “reading with parents and children”, the processor 130 may identify that only main datetime information 331 is datetime information included in one schedule package 330.

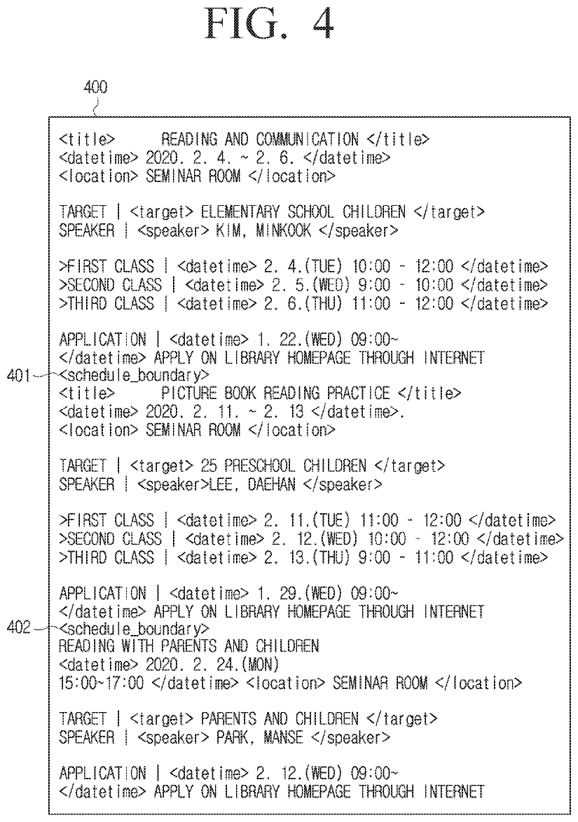

FIG. 4 is a diagram illustrating an example of obtaining boundary information according to various embodiments.

FIG. 4 illustrates a state 400 in which the processor 130 according to an embodiment of the disclosure identifies various types of information included in text information obtained by performing text recognition from an image which is same as the image described with reference to FIG. 3. The processor 130 according to an embodiment may obtain not only the information included in the image such as the title information, the datetime information, or the location information, but also schedule boundary information 401 and 402 not included in the image.

The processor 130 according to an embodiment of the disclosure may use a neural network model to divide schedule package. For example, the processor 130 according to an embodiment may obtain the schedule boundary information corresponding to each of the plurality of pieces of schedule information by inputting the text obtained from the image including the schedule information to the neural network model.

For example, the schedule boundary information corresponding to the schedule with the title “reading and communication” may be information 401 corresponding to a blank after a text regarding “application” among the pieces of text information corresponding to the schedule with the title “reading and communication”. In the same manner, the schedule boundary information corresponding to the schedule with the title “picture book reading practice” may be information 402 corresponding to a blank after a text regarding “application” among the pieces of text information corresponding to the schedule with the title “picture book reading practice”. In this case, the text information corresponding to the boundary information 401 and 402 may be information corresponding to the text regarding “application”.

The processor 130 according to an embodiment may update the schedule information of the user based on the obtained boundary information, and the main datetime information corresponding to each of the plurality of pieces of schedule information and the sub-datetime information corresponding to the main datetime information. The neural network model used by the processor 130 to obtain the main datetime information and the sub-datetime information corresponding to the main datetime information and the neural network model used to obtain the boundary information may be one model, but may be separate models.

The neural network model used by the processor 130 according to an embodiment of the disclosure to obtain the boundary information may include a model trained to output the text information corresponding to the schedule boundary information by receiving the plurality of pieces of text information. The processor 130 according to an embodiment may identify individual schedule packages based on the boundary information 401 and 402 obtained using the neural network model.

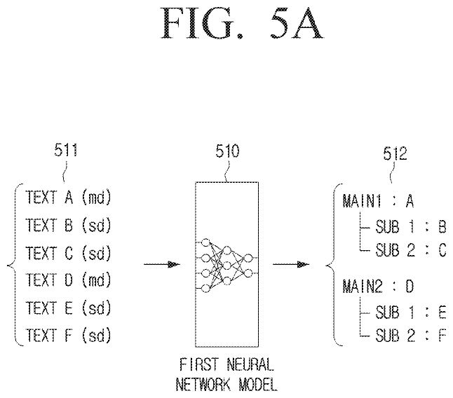

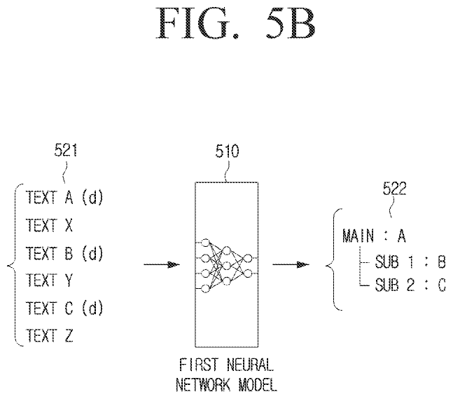

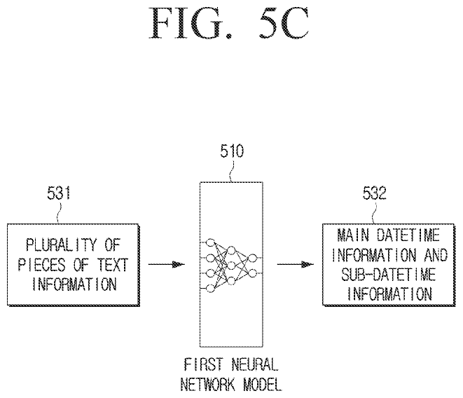

FIGS. 5A, 5B and 5C are diagrams illustrating examples of a first neural network model according to various embodiments.

Referring to FIG. 5A, a first neural network model 510 according to an embodiment may be a model trained by receiving a plurality of pieces of datetime information tagged as main datetime information or sub-datetime information. Input data 511 input to the first neural network model 510 may include a text A and a text D which are datetime information tagged (md) as the main datetime information and texts B, C, E, and F which are datetime information tagged (sd) as the sub-datetime information.

The first neural network model 510 according to an embodiment may be a model trained to output the main datetime information and the sub-datetime information corresponding to the main datetime information by receiving the input data 511 including the plurality of pieces of datetime information tagged as the main datetime information or the sub-datetime information. For example, the first neural network model 510 may be trained to output the main datetime information A and the sub datetime information B and C corresponding thereto, and the other main datetime information D and the sub-datetime information E and F corresponding thereto as output data 512.

FIG. 5B is a diagram illustrating an example method for training the first neural network model according to various embodiments. Referring to FIG. 5B, input data 521 input to the first neural network model 510 may include text information (texts A, B, and C) tagged (d) as the datetime information and text information (texts X, Y, and Z) not tagged as the datetime information.

The first neural network model 510 according to an embodiment may be a model trained to output the main datetime information and the sub-datetime information corresponding to the main datetime information by receiving the input data 521 including the text information tagged as the datetime information. For example, the first neural network model 510 may be trained to output the main datetime information A and the sub-datetime information B and C corresponding thereto as output data 522.

Referring to FIG. 5A, if the input data 511 including the individual tag for the main datetime information or the sub-datetime information is input to the first neural network model 510, it is advantageous in a viewpoint of efficiency of training, but human resources and time required to include the individual tags to the input data 511 may increase. On the other hand, referring to FIG. 5B, if the first neural network model 510 is trained through the input data 521 including only the tag corresponding to the datetime information, it is advantageous that the input data 521 is easily generated.

FIG. 5C is a diagram illustrating an example operation of the first neural network model 510 according to various embodiments.

The first neural network model 510 may obtain main datetime information corresponding to the schedule information and the sub-datetime information 532 corresponding to the main datetime information by receiving a plurality of pieces of text information 531 including the schedule information.

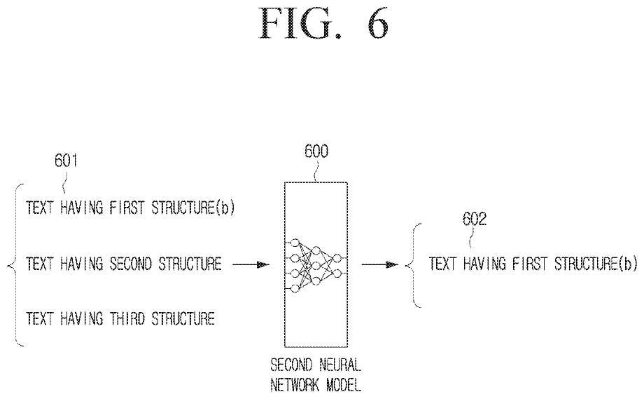

FIG. 6 is a diagram illustrating an example method for training a second neural network model according to various embodiments.

Referring to FIG. 6, a second neural network model 600 may receive a plurality of pieces of text information as input data 601. The input data 601 according to an embodiment may include a text having a first structure including a boundary tag b as a text corresponding to the boundary information, and a text having a second structure and a text having a third structure not corresponding to the boundary information.

The second neural network model 600 may output only the text having the first structure including the boundary tag b as the text corresponding to the boundary information among the input data 601 by including the text having the first structure in the output data 602.

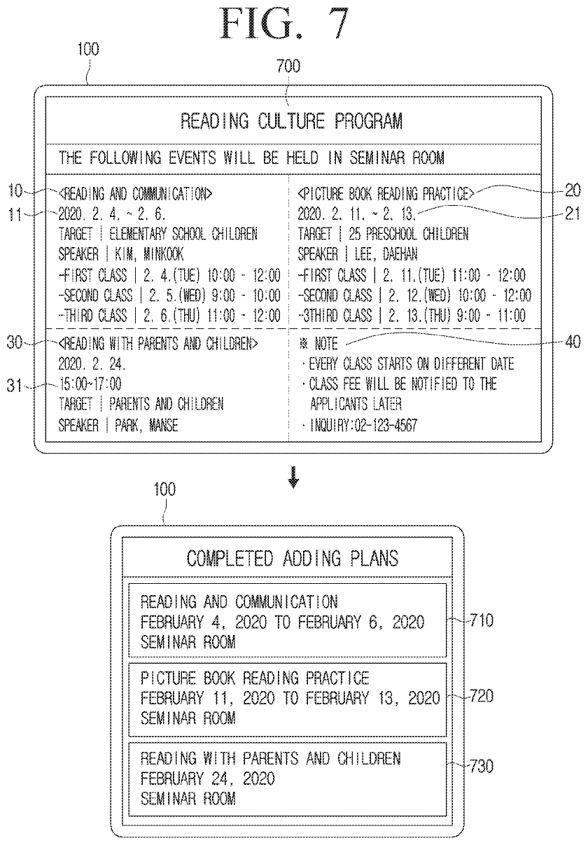

FIG. 7 is a diagram illustrating an example method for adding a plurality of multiple schedules according to various embodiments. Referring to FIG. 7, a schedule with a title A is expressed as “A”.

The electronic apparatus 100 according to an embodiment of the disclosure may display an image 700 including information on a plurality of multiple schedules. The image 700 displayed by the electronic apparatus 100 may include information on multiple schedules “reading and communication 10” and “picture book reading practice 20”, and a single schedule “reading with parents and children 30”. In addition, the image may include additional information 40 on the plurality of schedules.

The electronic apparatus 100 according to an embodiment may identify main datetime information corresponding to each of the plurality of schedules. For example, the electronic apparatus 100 may identify main datetime information “Feb. 4, 2020 to Feb. 6, 2020 (11)” corresponding to the “reading and communication 10”. In addition, the electronic apparatus 100 may identify main datetime information “Feb. 11, 2020 to Feb. 13, 2020 (21)” corresponding to the “picture book reading practice 20”. In the same manner as described above, the electronic apparatus 100 may identify main datetime information “15:00 to 17:00 on Feb. 4, 2020” corresponding to the “reading with parents and children 30”.

The electronic apparatus 100 according to an embodiment may identify remaining datetime information except for the identified main datetime information 11, 21, and 31 as sub-datetime information, and identify the identified main datetime information and the sub-datetime information corresponding to each main datetime information as datetime information belonging to one schedule package.

As a result, the electronic apparatus 100 may update the schedule information of the user based on the main datetime information corresponding to the “reading and communication 10”, the “picture book reading practice 20”, and the “reading with parents and children 30” and the sub-datetime information corresponding to each main datetime information. In addition, the electronic apparatus 100 may display UIs 710, 720, and 730 for providing the updated schedule information. For example, the electronic apparatus 100 may display each of the UI 710 for providing schedule information on the “reading and communication 10”, the UI 720 for providing schedule information on the “picture book reading practice 20”, and the UI 730 for providing schedule information on the “reading with parents and children 30”.

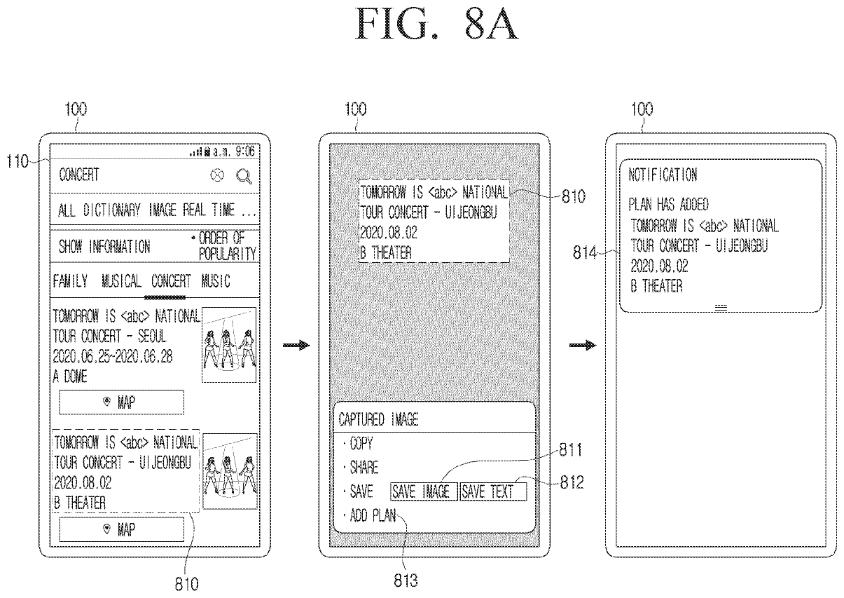

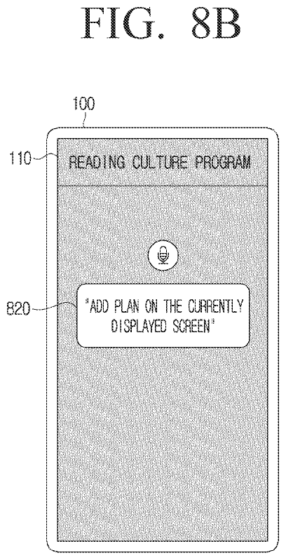

FIGS. 8A and 8B are diagrams illustrating various examples of user commands according to various embodiments.

FIG. 8A is a diagram illustrating a user command by a touch input among user commands for adding schedules according to an embodiment.

The electronic apparatus 100 according to an embodiment may display an image including schedule information through the display 110. An image according to an embodiment may be provided through Internet browser or application screen or may be provided through at least one of an e-mail, a messenger, a text message, or a result screen captured through a camera (not illustrated). In this case, the user may select a region 810 of the image provided through the touch input.

The electronic apparatus 100 according to an embodiment may display a UI for selecting functions such as copying, sharing, storing, and adding plans for the selected region 810 of the image. The user may store the region 810 of the image as an image (811) or as a text (812). If the user selects the function of storing the region as a text (812) through the UI, the electronic apparatus 100 may store a text obtained through the OCR process of the image 810.

In addition, if an “add plan (813)” function is selected, the electronic apparatus 100 according to an embodiment may update the user schedule by extracting schedule information included in the region 810 of the image. For example, the electronic apparatus 100 may update the user schedule based on main datetime information “Aug. 2, 2020” corresponding to “tomorrow is <abc> national tour concert-Uijeongbu”. The electronic apparatus 100 may display a UI 814 for providing information on a schedule added through the schedule update.

FIG. 8B is a diagram illustrating an example user command by a voice input among user commands for adding schedules according to various embodiments.

The electronic apparatus 100 according to an embodiment may include a user inputter (not illustrated). The user inputter (not illustrated) according to an embodiment may be implemented as a mechanical module such as a voice recognition sensor or a button. When a user manipulation for starting voice recognition is input through the user inputter, the electronic apparatus 100 may display a guide UI for guiding the start of utterance.

When the user who receives the guide UI inputs a voice corresponding to the user command for adding schedules, the electronic apparatus 100 may display a UI 820 for giving a feedback of the content of the input voice to the user. If a predetermined period of time elapses or additional user manipulation is input after the corresponding UI 820 is displayed, the electronic apparatus 100 may perform an operation corresponding to the user command included in the input voice. For example, when a voice “Add plans on the currently displayed screen” is input, the electronic apparatus 100 may update the user schedule by extracting the schedule information included in the image which is being displayed by the electronic apparatus 100 when the voice recognition is started.

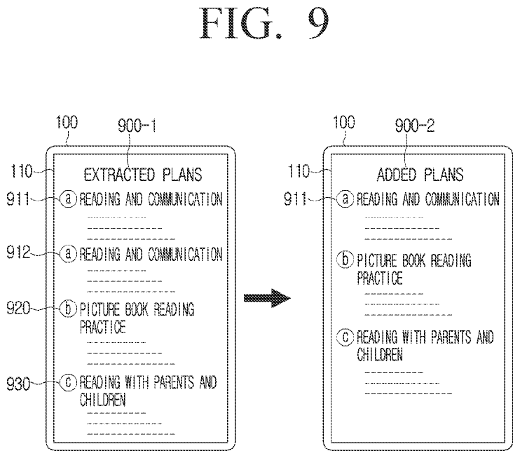

FIG. 9 is a diagram illustrating an example method for removing the multiple schedule according to various embodiments.

The electronic apparatus 100 according to an embodiment may extract the schedule information included in the image, and provide a UI 900-1 for providing information on the extracted plans to the user via the display 110. The image including the schedule information may include a plurality of pieces of information on the same schedule, and accordingly, the extracted plan may also include a plurality of pieces of information on the same schedule.

For example, the extracted plan illustrated in FIG. 9 may include a plurality of pieces of schedule information 911 and 912 corresponding to the “reading and communication”. The electronic apparatus 100 according to an embodiment may perform a process of removing the overlapped schedule information with respect to “reading and communication 911 and 912” having schedule overlapped in the schedule information included in the extracted plan, and may not perform a separate process with respect to “picture book reading practice 920” and “reading with parents and children 930” not having overlapped schedules.

For example, the electronic apparatus 100 may perform the overlap removal process by selecting the information 911 that is extracted first among the “reading and communication 911 and 912” having the overlapped schedule and then removing the information 912 that is not selected. The electronic apparatus 100 may update the user schedule based on the schedule information extracted after removing the overlapped information.

As a result, the “reading and communication 911”, the “picture book reading practice 920”, and the “reading with parents and children 930” may be added to the user schedule, and the electronic apparatus 100 may display a UI 900-2 for providing the information on the added schedules via the display 110.

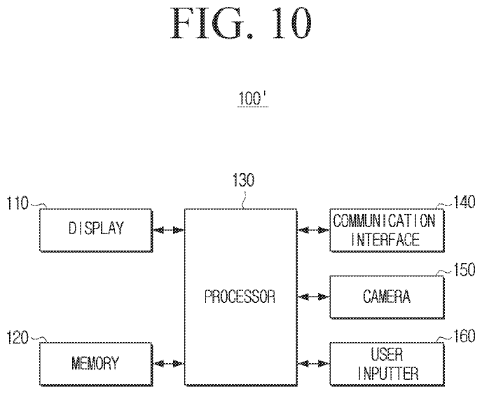

FIG. 10 is a block diagram illustrating an example configuration of the electronic apparatus according to various embodiments.

Referring to FIG. 10, an electronic apparatus 100′ may include the display 110, the memory 120, the processor (e.g., including processing circuitry) 130, a communication interface (e.g., including communication circuitry) 140, a camera 150, and a user inputter (e.g., including input circuitry) 160. A detailed description of the elements illustrated in FIG. 10 which are overlapped with the elements illustrated in FIG. 2 may not be repeated here.

The communication interface 140 may include various communication circuitry and input and output various types of data. For example, the communication interface 140 may transmit and receive various types of data with an external apparatus (e.g., source apparatus), an external storage medium (e.g., USB memory), or an external server (e.g., Webhard) through communication methods such as AP-based Wi-Fi (wireless LAN network), Bluetooth, Zigbee, wired/wireless local area network (LAN), a wide area network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), optical or coaxial connection.

The camera 150 may obtain an image by capturing a region in a field of view (FoV) of the camera. The camera 150 may include a lens which focuses a visible ray or a signal received by being reflected by an object on an image sensor, and the image sensor capable of detecting the visible ray or signal. Herein, the image sensor may include 2D pixel array divided into a plurality of pixels.

The user inputter 160 may include various input circuitry and generate input data for controlling the operations of the electronic apparatus 100. The user inputter 160 may be configured with a keypad, a dome switch, a touch pad (static pressure/electrostatic), a jog wheel, a jog switch, a voice recognition sensor, and the like.

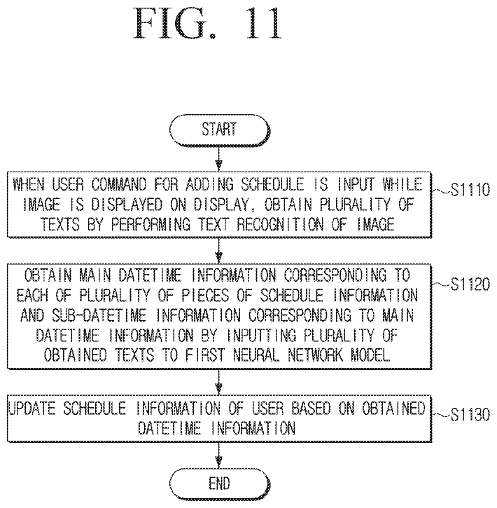

FIG. 11 is a flowchart illustrating an example method of controlling the electronic apparatus according to various embodiments.

A method for controlling the electronic apparatus according to an example embodiment includes, based on a user command for adding a schedule being input while an image is displayed on the display, obtaining a plurality of texts by performing text recognition of the image (S1110). The method includes obtaining main datetime information corresponding to each of a plurality of pieces of schedule information and sub-datetime information corresponding to the main datetime information by inputting the plurality of obtained texts to a first neural network model (S1120). The method includes updating schedule information of a user based on the obtained datetime information (S1130). The first neural network model may be trained to output main datetime information and sub-datetime information corresponding to the main datetime information by receiving a plurality of pieces of datetime information.

The plurality of pieces of datetime information input to the first neural network model to train the first neural network model may include first datetime information tagged as main datetime information and second datetime information tagged as sub-datetime information.

The first neural network model may be trained to output text information corresponding to schedule boundary information by receiving a plurality of pieces of text information, and the method may further include obtaining schedule boundary information corresponding to each of the plurality of pieces of schedule information by inputting the plurality of obtained texts to the first neural network model. The updating the schedule information of the user (S1130) may include updating the schedule information of the user based on the obtained schedule boundary information, the main datetime information corresponding to each of the plurality of pieces of schedule information, and the sub-datetime information corresponding to the main datetime information

The method may further include obtaining schedule boundary information corresponding to each of the plurality of pieces of schedule information by inputting the plurality of obtained texts to a second neural network model. The updating the schedule information of the user (S1130) may include updating the schedule information of the user based on the obtained schedule boundary information, the main datetime information corresponding to each of the plurality of pieces of schedule information, and the sub-datetime information corresponding to the main datetime information. The second neural network model may be trained to output text information corresponding to schedule boundary information by receiving a plurality of pieces of text information.

The method may further include obtaining schedule title information, location information, and datetime information corresponding to each of the plurality of pieces of schedule information by inputting the plurality of obtained texts to the first neural network model. The updating the schedule information of the user (S1130) may include updating the schedule information of the user based on the obtained schedule title information, location information, and datetime information.

The first neural network model may be trained to divide and output schedule title information, location information, and datetime information by receiving a plurality of pieces of text information, and a plurality of pieces of text information input to the first neural network model to train the first neural network model may include a first text tagged as schedule title information, a second text tagged as location information, and a third text tagged as datetime information.

The method may further include, based on dates and times of a plurality of pieces of main datetime information obtained from the first neural network model being overlapped, selecting one of the plurality of pieces of main datetime information. The updating the schedule information of the user (S1130) may include updating the schedule information of the user based on the selected main datetime information and sub-datetime information corresponding to the selected main datetime information.

The method may further include displaying a guide UI including a plurality of pieces of schedule information obtained from the first neural network model. The updating the schedule information of the user (S1130) may include updating the schedule information of the user based on schedule information selected on the guide UI.

The user command for adding a schedule may include at least one of a touch input for the image or a user voice.

The method may further include dividing the plurality of texts in a predetermined unit, normalizing the divided texts, and tokenizing the normalized text and inputting the tokenized text to the first neural network model.

The methods according to various example embodiments of the disclosure described above may be implemented in a form of an application installable in the electronic device of the related art.

In addition, the methods according to various embodiments of the disclosure described above may be implemented simply by the software upgrade or hardware upgrade in the electronic device of the related art.

Further, the embodiments of the disclosure described above may be performed through an embedded server provided in the electronic device or an external server of the electronic apparatus.

The embodiments described above may be implemented in a recording medium readable by a computer or a similar device using software, hardware, or a combination thereof. In some cases, the embodiments described in this disclosure may be implemented as the processor 130. According to the implementation in terms of software, the embodiments such as procedures and functions described in this disclosure may be implemented as separate software modules. Each of the software modules may perform one or more functions and operations described in this disclosure.

Computer instructions for executing processing operations of the electronic apparatus 100 according to various embodiments of the disclosure descried above may be stored in a non-transitory computer-readable medium. When the computer instructions stored in such a non-transitory computer-readable medium are executed by the processor, the computer instructions may enable a specific machine to execute the processing operations on the electronic apparatus 100 according to various embodiments described above.

The non-transitory computer-readable medium may refer to a medium that semi-permanently stores data and is readable by a machine. Specific examples of the non-transitory computer-readable medium may include a CD, a DVD, a hard disk drive, a Blu-ray disc, a USB, a memory card, and a ROM.

While the disclosure has been illustrated and described with reference to various example embodiments, it will be understood that the various example embodiments are intended to be illustrative, not limiting. It will be further understood by those skilled in the art that various modifications can be made, without departing from the true spirit and full scope of the disclosure, including the appended claims and their equivalents.

What is claimed is:

1. An electronic apparatus comprising:
a display;
a memory storing at least one instruction; and
a processor connected to the memory and the display and configured to control the electronic apparatus,
wherein the processor, by executing the at least one instruction, is configured to:
based on receiving a command for adding a schedule being input while an image is displayed on the display, obtain a plurality of texts by performing text recognition of the image,
obtain main datetime information corresponding to each of a plurality of pieces of schedule information and sub-datetime information corresponding to the main datetime information by causing the plurality of obtained texts to be provided to a first neural network model,
update schedule information of a user based on the obtained datetime information, and
wherein the first neural network model is configured to be trained to output main datetime information and sub-datetime information corresponding to the main datetime information based on receiving a plurality of pieces of datetime information.

2. The apparatus according to claim 1, wherein the plurality of pieces of datetime information input to the first neural network model to train the first neural network model comprises: first datetime information tagged as main datetime information and second datetime information tagged as sub-datetime information.

3. The apparatus according to claim 1, wherein the first neural network model is configured to be trained to output text information corresponding to schedule boundary information based on receiving a plurality of pieces of text information, and
wherein the processor is configured to:
obtain schedule boundary information corresponding to each of the plurality of pieces of schedule information by causing the plurality of obtained texts to be provided to the first neural network model; and
update the schedule information of the user based on the obtained schedule boundary information, the main datetime information corresponding to each of the plurality of pieces of schedule information, and the sub-datetime information corresponding to the main datetime information.

4. The apparatus according to claim 1, wherein the processor is configured to:
obtain schedule boundary information corresponding to each of the plurality of pieces of schedule information by causing the plurality of obtained texts to be provided to a second neural network model; and
update the schedule information of the user based on the obtained schedule boundary information, the main datetime information corresponding to each of the plurality of pieces of schedule information, and the sub-datetime information corresponding to the main datetime information, and
wherein the second neural network model is configured to be trained to output text information corresponding to schedule boundary information based on receiving a plurality of pieces of text information.

5. The apparatus according to claim 1, wherein the processor is configured to:
obtain schedule title information, location information, and datetime information corresponding to each of the plurality of pieces of schedule information by causing the plurality of obtained texts to be provided to the first neural network model; and
update the schedule information of the user based on the obtained schedule title information, location information, and datetime information.

6. The apparatus according to claim 5, wherein the first neural network model is configured to be trained to divide and output schedule title information, location information, and datetime information based on receiving a plurality of pieces of text information, and
wherein a plurality of pieces of text information provided to the first neural network model to train the first neural network model comprises: a first text tagged as schedule title information, a second text tagged as location information, and a third text tagged as datetime information.

7. The apparatus according to claim 1, wherein the processor is configured, based on dates and times of a plurality of pieces of main datetime information obtained from the first neural network model being overlapped, to: select one of the plurality of pieces of main datetime information, and update the schedule information of the user based on the selected main datetime information and sub-datetime information corresponding to the selected main datetime information.

8. The apparatus according to claim 1, wherein the processor is configured to:
control the display to display a guide UI comprising a plurality of pieces of schedule information obtained from the first neural network model; and
update the schedule information of the user based on schedule information selected on the guide UI.

9. The apparatus according to claim 1, wherein the command for adding a schedule comprises at least one of a touch input for the image or a voice.

10. The apparatus according to claim 1, wherein the processor is configured to:
divide the plurality of texts in a predetermined unit;
normalize the divided texts; and
tokenize the normalized text and cause the tokenized text to be provided to the first neural network model.

11. A method for controlling an electronic apparatus comprising a display and a memory, the method comprising:
based on receiving a command for adding a schedule being input while an image is displayed on the display, obtaining a plurality of texts by performing text recognition of the image;
obtaining main datetime information corresponding to each of a plurality of pieces of schedule information and sub-datetime information corresponding to the main datetime information by inputting the plurality of obtained texts to a first neural network model; and
updating schedule information of a user based on the obtained datetime information,
wherein the first neural network model is configured to be trained to output main datetime information and sub-datetime information corresponding to the main datetime information by receiving a plurality of pieces of datetime information.

12. The method according to claim 11, wherein the plurality of pieces of datetime information input to the first neural network model to train the first neural network model comprises: first datetime information tagged as main datetime information and second datetime information tagged as sub-datetime information.

13. The method according to claim 11, wherein the first neural network model is configured to be trained to output text information corresponding to schedule boundary information by receiving a plurality of pieces of text information, and
wherein the method further comprises:
obtaining schedule boundary information corresponding to each of the plurality of pieces of schedule information by inputting the plurality of obtained texts to the first neural network model, and
wherein the updating the schedule information of the user comprises,
updating the schedule information of the user based on the obtained schedule boundary information, the main datetime information corresponding to each of the plurality of pieces of schedule information, and the sub-datetime information corresponding to the main datetime information.

14. The method according to claim 11, further comprising:
obtaining schedule boundary information corresponding to each of the plurality of pieces of schedule information by inputting the plurality of obtained texts to a second neural network model,
wherein the updating the schedule information of the user comprises,
updating the schedule information of the user based on the obtained schedule boundary information, the main datetime information corresponding to each of the plurality of pieces of schedule information, and the sub-datetime information corresponding to the main datetime information, and
wherein the second neural network model is configured to be trained to output text information corresponding to schedule boundary information by receiving a plurality of pieces of text information.

15. The method according to claim 11, further comprising:
obtaining schedule title information, location information, and datetime information corresponding to each of the plurality of pieces of schedule information by inputting the plurality of obtained texts to the first neural network model,
wherein the updating the schedule information of the user comprises,
updating the schedule information of the user based on the obtained schedule title information, location information, and datetime information.
